(19) United States
(12) Patent Application Publication
(10) Pub. No.: US 2018/0315416 A1
(43) Pub. Date: Nov. 1, 2018

(54) MICROPHONE WITH PROGRAMMABLE PHONE ONSET DETECTION ENGINE

(71) Applicant: Knowles Electronics, LLC, Itasca, IL (US)

(72) Inventors: Kim Spetzler Berthelsen, Roskilde (DK); Dibyendu Nandy, Naperville, IL (US); Henrik Thompsen, Holte (DK); Sridhar Pilli, Itasca, IL (US)

(73) Assignee: Knowles Electronics, LLC, Itasca, IL (US)

(21) Appl. No.: 15/770,117

(22) PCT Filed: Oct. 21, 2016
(86) PCT No.: PCT/US2016/058212

§ 371 Date: Apr. 20, 2018

Related U.S. Application Data
(60) Provisional application No. 62/245,028, filed on Oct. 22, 2015.
(60) Provisional application No. 62/245,036, filed on Oct. 22, 2015.

(51) Int. Cl. G10L 15/02; G10L 25/51; H04R 19/04; G10L 25/21; G10L 25/18; G10L 15/00; H04R 3/04; G10L 25/78

(52) U.S. Cl. CPC G10L 15/02; G10L 25/51; H04R 19/04; G10L 25/21; G10L 2015/025; G10L 15/005; H04R 3/04; G10L 25/78; H04R 2201/003; G10L 25/18

(57) ABSTRACT

At a configurable filter bank, commands or command signals are received from an external processing device. The commands or command signals are effective to configure and connect selective ones of the plurality of elements in the filter bank. An acoustic signal is received from a transducer. The acoustic signal is converted to a PDM signal and the PDM signal is converted to a PCM signal.

### CROSS REFERENCE TO RELATED APPLICATIONS

This application claims the benefit of and priority to U.S. Provisional Patent Application No. 62/245,028, filed Oct. 22, 2015, and U.S. Provisional Patent Application No. 62/245,036, filed Oct. 22, 2015, both of which are incorporated herein by reference in their entireties.

### TECHNICAL FIELD

This application relates to acoustic activity detection (AAD) approaches and voice activity detection (VAD) approaches, and their interfacing with other types of electronic devices.

### BACKGROUND

Voice activity detection (VAD) approaches and acoustic activity detection (AAD) approaches are important components of speech recognition software and hardware. For example, recognition software constantly scans the audio signal of a microphone searching for voice activity, usually, with a MIPS intensive algorithm. Since the algorithm is constantly running, the power used in this voice detection approach is significant.

Microphones are also disposed in mobile device products such as cellular phones. These customer devices have a standardized interface. If the microphone is not compatible with this interface it cannot be used with the mobile device product.

Many mobile devices products have speech recognition included with the mobile device. However, the power usage of the algorithms are taxing enough to the battery that the feature is often enabled only after the user presses a button or wakes up the device. In order to enable this feature at all times, the power consumption of the overall solution must be small enough to have minimal impact on the total battery life of the device. As mentioned, this has not occurred with existing devices.

Because of the above-mentioned problems, some user dissatisfaction with previous approaches has occurred.

### BRIEF DESCRIPTION OF THE DRAWINGS

For a more complete understanding of the disclosure, reference should be made to the following detailed description and accompanying drawings wherein:

FIG. 1 comprises a block diagram of a microphone according to various embodiments;

FIG. 2 comprises a block diagram of a filter bank according to various embodiments;

FIG. 3 comprises a block diagram of another filter bank according to various embodiments;

FIG. 4 comprises a flow chart of the operation of the microphone and the filter banks according to various embodiments;

FIG. 5 comprises a block diagram of a portion of a programmable or configurable filter bank according to various embodiments;

FIG. 6 comprises a graph showing some of the operations of the filter bank according to various embodiments;

FIG. 7 comprises a block diagram of a half-band filter according to various embodiments;

FIG. 8 comprises a graph of the low frequency output of a half band filter according to various embodiments;

FIG. 9 comprises a graph of the high frequency output of a half band filter according to various embodiments;

FIG. 10A comprises a block diagram of a half band filter according to various embodiments;

FIG. 10B comprises a block diagram of an implementation of the half band filter of FIG. 10A according to various embodiments;

FIG. 11 comprises an example of a programmable filter bank according to various embodiments;

FIG. 12 comprises another example of a programmable filter bank according to various embodiments;

FIG. 13 comprises a flowchart of the operation of the backend that is used to determine partial phrases in received speech according to various embodiments; and

FIG. 14 comprises spectrograms of differing number of bands and showing peak energy points in the bands that show certain patterns according to various embodiments.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are described herein that detect phoneme utterances or phones using a filter bank that can be programmable or configurable. In particular, the number and connections between the different functional electronic blocks that are disposed within the filter bank can be adjusted on-the-fly according to commands (or other control signals) received from external processing devices. In so doing, a much more flexible approach is provided that can be adapted to the needs of the user or the system.

As used herein, a “phone” in the context of linguistics and speech recognition is the speech utterance or sound. A “phoneme” is an abstraction of a set of equivalent speech sounds or “phones”. Thus, a phone is a phoneme sound as uttered during speech. For the purposes of this description, a phone or phoneme utterance may be considered to be the same. In some aspects, a front-end smart microphone detects a particular speech sound, specifically the onset or initial phone or phoneme sound of a trigger phrase. In aspects, the system is operated to reduce power by robustly triggering on the initial phone in a wide range of ambient acoustic interferences to minimize false triggers due to other phonemes. In some examples, the present approaches have the phone detector that may be tuned to different phones and also in turn tuned to a particular user through configurable parameters. These parameters are loaded on request, for example, using an I2C, UART, SPI or other suitable interface at reboot from system flash memory. The parameters themselves may be available through feature extraction techniques derived from a sufficient set of training examples in case of a generic trigger phrase. The parameters may also be obtained via specific training to an end-user's voice thus incorporating the users vocal characteristics in the manner the trigger is uttered.

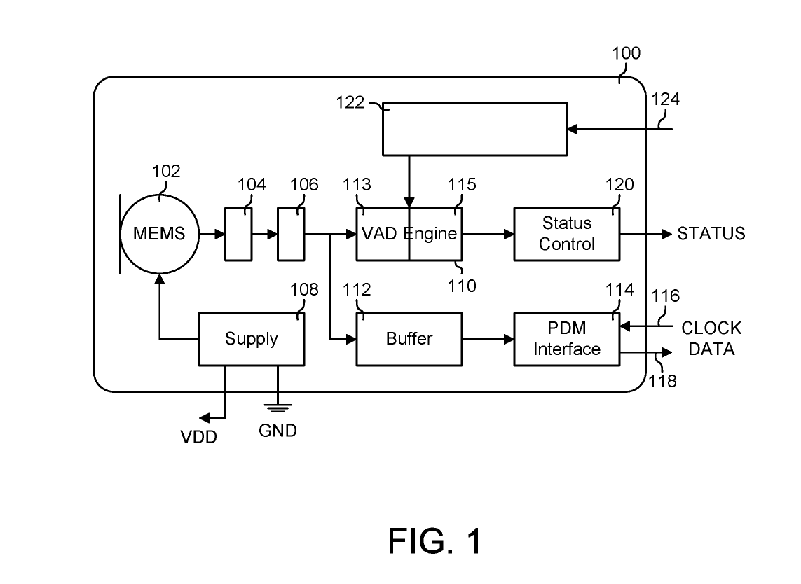

Referring now to FIG. 1, one example of a microphone system 100 is described. The microphone system 100 includes a transducer 102 (e.g., a micro electro mechanical system (MEMS) transducer with a diaphragm and back plate), a sigma delta converter 104, a decimation filter 106, a power supply 108, a specialized phone selecting voice activity detection (VAD) (or acoustic activity detection (AAD)) engine 110, a buffer 112, a PDM interface 114, a clock line 116, a data line 118, a status control module 120, and a command/control interface 122 receiving commands or control signals 124.

The transducer 102 converts sound energy into electrical signals. The sigma delta converter 104 converts the analog signals into pulse density modulation (PDM) signals, where the PDM signal may be constituted as a single or multi-bit noise shaped digital signal representing the analog signal. The converter 106 converts the PDM signals into pulse code modulation (PCM) signals, where the PCM signal is a multi-bit signal filtered to eliminate aliasing noise and decimated to an appropriate sampling frequency to maintain the bandwidth of interest, e.g. a speech signal at 16 kHz and 16 bits with a bandwidth of 8 kHz in accordance with the Nyquist theorem. The power supply 108 supplies power to the various components of the microphone 100.

The VAD engine 110 detects phones. As used herein, a phone is a part of a word or phrase as it sounds when uttered, Example the [a] sound in “make” as compared to “apple” constitute different phones. Another example could be [sh] in “shut” compared to [ch] in “church”. Other examples of phones are possible.

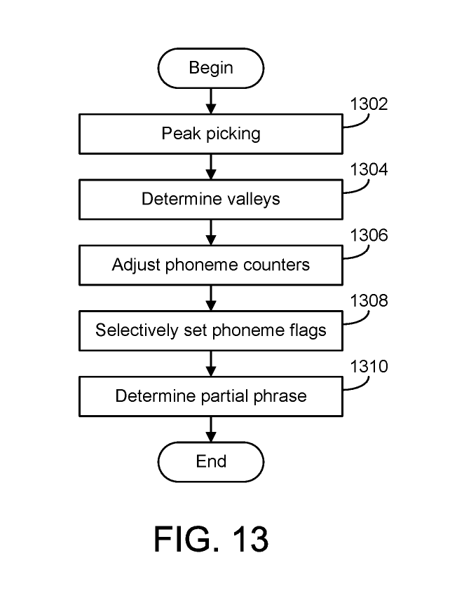

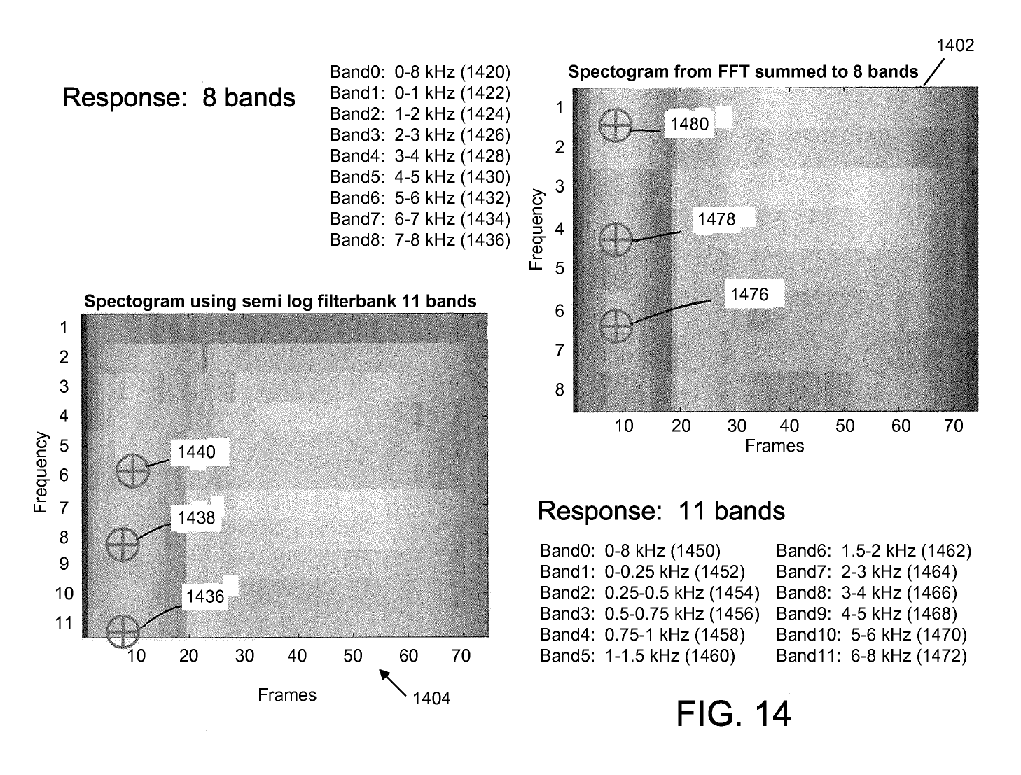

In one aspect, the VAD engine 110 includes a front end 113 and a back end 115. The front end 113 in one aspect includes a filter bank and related feature extractors. In another aspect the back end 115 includes decision logic acting on the features extracted from the front end to determine the onset of the initial phone. In another aspect, both the front end 113 and the back end 115 are configurable or programmable. That is, the configuration of these components may be changed during manufacturing or on-the-fly after manufacturing has been completed. In another example, only the back end 115 is configurable or programmable. In still another example, neither the front end 113 nor the back end 115 are configurable. It will be appreciated that the elements 113 and 115 may be any combination of hardware and/or software elements. The operation of the backend 115 is described in greater detail below with respect to FIG. 13 and FIG. 14.

The buffer 112 temporarily stores the incoming data so that the VAD engine 110 can determine whether it has detected the initial phone or other acoustic activity of interest. The PDM interface 114 converts PCM data to PDM data. The clock line 116 supplies an external clock signal from an external processing device to the microphone 100. In one aspect, the external clock signal on the clock line 116 is supplied upon detection of the initial phone or other acoustic activity of interest. The data line 118 transmits data from the microphone 100 to external processing devices.

The status control module 120 signals to the external processor or processing device when the initial phone (or acoustic) activity detection has occurred. In one aspect, the status control module 120 outputs a “1” when the initial phone (or acoustic) detection occurs. The command/control interface 122 receives commands 124 from external processing devices. This may include a separate clock line that clocks data on a data line. The clock line may clock data received on the data line. The data received on the data line may include commands that configure the front end 113 and/or the back end 115 to operate with a particular user. Consequently, the phone detection approaches deployed at the microphone are customized to take into account characteristics of the speech of a particular user.

Filters or filter banks (also known as analysis filter banks) in the front end 113 break the incoming signal into different frequency bands. The frequency bands are received by an energy estimator module. The estimated energy is obtained for the different frequency bands. At the back end 115, the estimated energies for the set of frequency bands are compared to the expected energies for the set of frequency bands of a given phone and a determination is made if there is a match. If there is a match, then initial phone occurrence (or acoustic activity of interest) has been determined.

A variety of different types of filter banks can be used. In one example, a QMF Half band filter bank is used with Filter and Decimate approach to reduce the processing rate requirements.

In one example, the filter bank 113 includes 3 stages. 8 bands with equal bandwidth (1 kHz each) are produced by the filter bank 113 and the sampling rate (Fs) is 2 kHz after the third stage.

In another example, 5 levels are used in the filter bank 113. The filter bank 113 operates as a semi-log filter bank, achieves finer resolution at low frequencies, and is especially useful for speech analysis. This filter bank produces 11 bands with variable bandwidth and a sampling rate (Fs) of 4 kHz (maximum) to Fs of 0.5 kHz (minimum).

It will be appreciated that the filter banks are programmable. The filter banks are created and their configurations changed on-the-fly during system operation. Thus, to accommodate a first requirement a first configuration may be used and to accommodate a second requirement a second configuration is used. The different requirements could be due to different algorithms, product configurations, user experiences or other purposes. Other configurations of the filter banks are also possible.

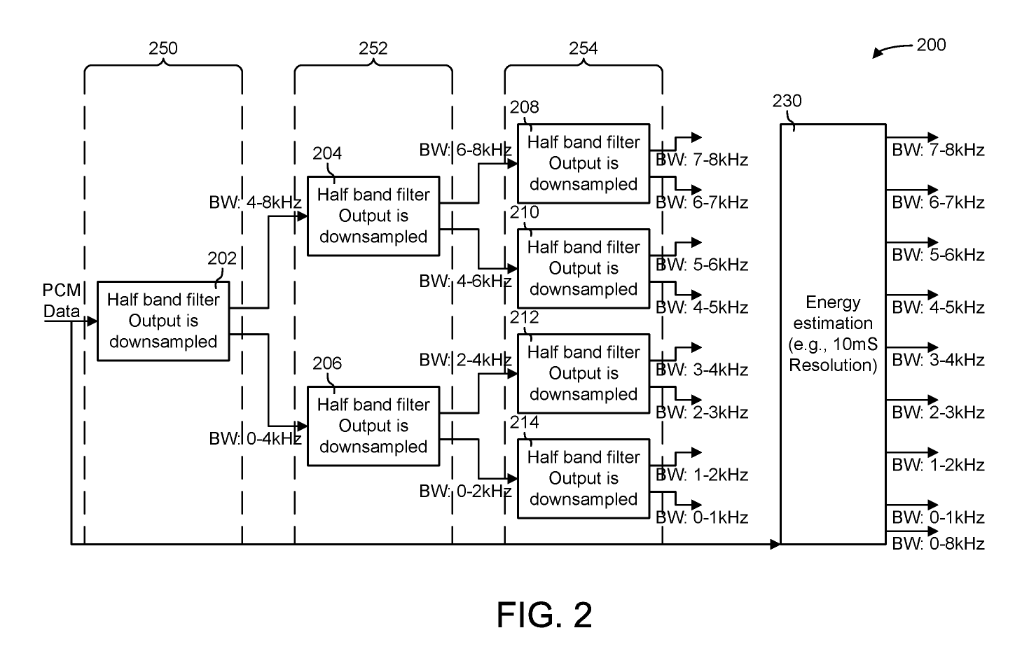

Referring now to FIG. 2, one example of a configurable filter bank 200 (e.g., a filter bank in the front end 113) is described. The filter bank 200 includes a first filter element 202, a second filter element 204, a third filter element 206, a fourth filter element 208, a fifth filter element 210, a sixth filter element 212, and a seventh filter element 214. The filter bank 200 also includes an energy estimation block 230. A first level 250 includes the first filter element 202. A second level includes the second filter element 204 and the third filter element 206. The third level 254 includes the fourth filter element 208, the fifth filter element 210, the sixth filter element 212, and the seventh filter element 214

In this example, the filter bank 200 includes the three stages 250, 252, and 254. By “stages” and as used herein, it is meant that the filter elements at each stage work at a sampling rate which is half the rate of the previous stage. Consequently, the bank 200 produces 8 bands with equal bandwidths (e.g., approximately 1 kHz each) and with a sampling rate (Fs)=2 kHz.

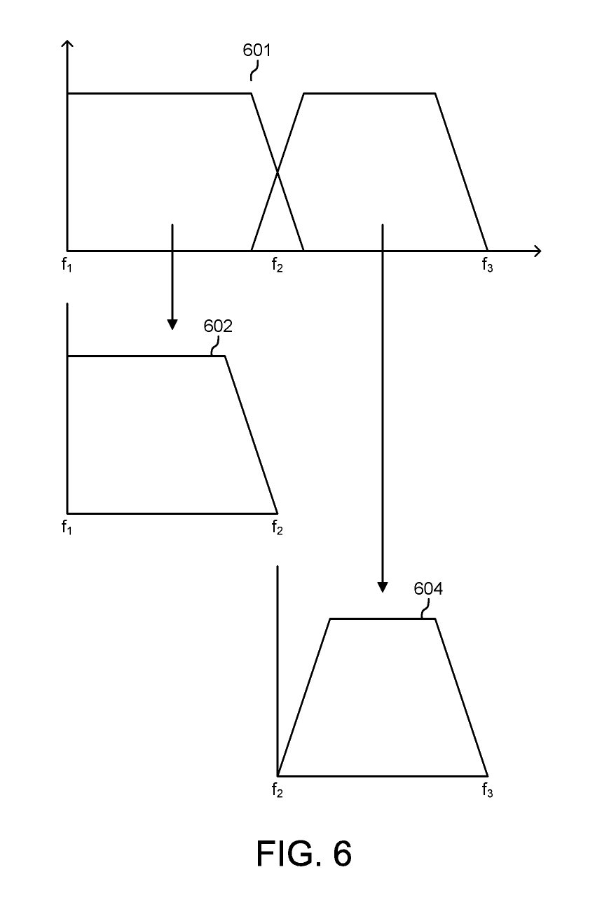

It will be understood that signals enter each of the filter elements and as shown in FIG. 6, and then the signal is broken into bands having particular bandwidths. For example, a signal with bandwidth 0-8 kHz enters first filter element 202, where it is split into two signals: one with a bandwidth of 0-4 kHz and the other with a bandwidth of 4-8 kHz. The signal of bandwidth 4-8kHz is then sent to the second filter element 204, where the signal is split into a signal of bandwidth 6-8 kHz and another signal with 4-6 kHz bandwidth. This type of bandwidth splitting occurs among the filter elements. The signals represent a single instant in time.

The signals then reach the energy estimation block. At the energy estimator, the estimated energy for each band is obtained. This may be obtained in several ways. In one aspect, for example, a first order autoregressive or infinite impulse response filter model operating on the absolute value of the signal from each band. This may be shown by the following equation:

E_est(k,n)=(1−time_avg)×E_est(k,n-1)+time_avg×abs(x(k,n))

where x(k,n) is the signal output for the frequency band k for the time sample n, time_avg is the averaging time for the energy estimator defined by the equation and E_est(k,n) is the estimated energy, The estimated energy is read at fixed intervals. In certain aspects, the fixed time intervals could be 5 ms, 8 ms, 10 ms or another suitable interval.

In another aspect, the energy may be estimated by an accumulate and dump method at the fixed interval rate, as shown by:

E_est(k,n)=E_est(k,n)+abs(x(k,n))

The energy estimate is reset at the end of the fixed interval after being read. Here n corresponds only to the set of samples corresponding to a pre-defined fixed interval.

After being processed by the front end filter bank, the energy estimates may be sent to the back end where a comparison is made of the estimates to predetermined patterns where each pattern represents a different phone. A predetermined set of criteria may be used to determine if a match is determined. When a match is determined, an indication of the match and an indication of the phone detected may be sent, for example, to an external processing device.

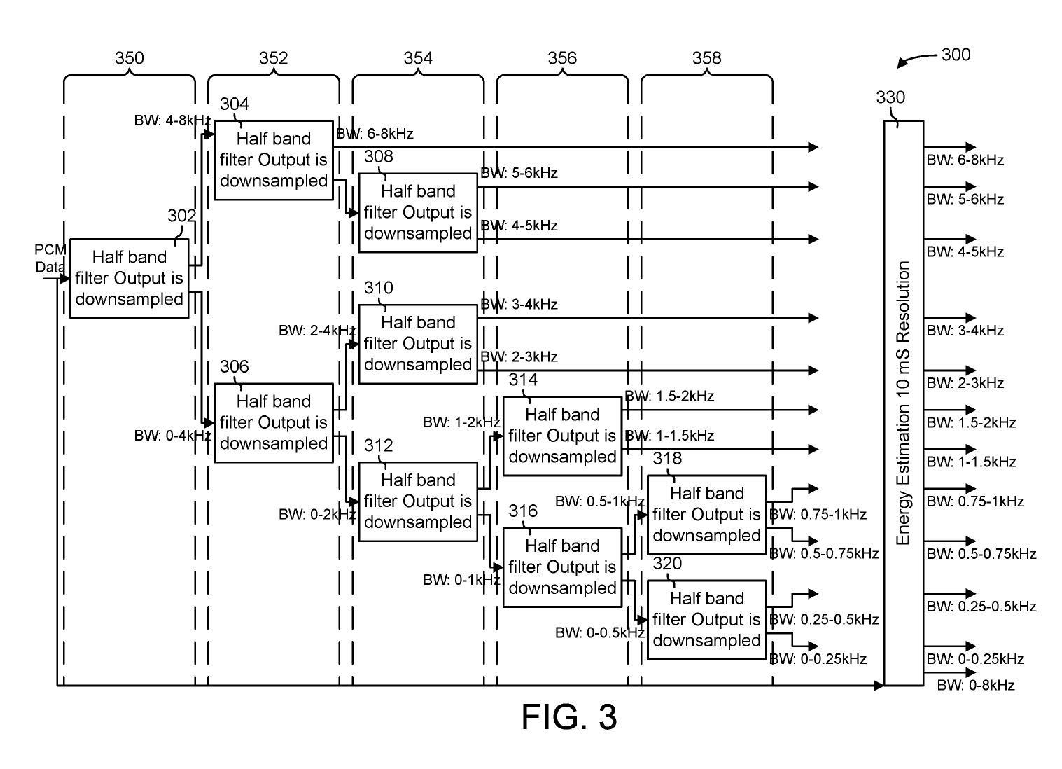

Referring now to FIG. 3, another example of a filter bank 300 (e.g., a filter bank in the front end 113) is described. The filter bank 300 includes a first filter element 302, a second filter element 304, a third filter element 306, a fourth filter element 308, a fifth filter element 310, a sixth filter element 312, a seventh filter element 314, an eighth filter element 316, a ninth filter element 318, and a tenth filter element 320. The filter bank 300 also includes an energy estimation block 330.

A first level 350 includes the first filter element 302. A second level includes the second filter element 304 and the third filter element 306. The third level 354 includes the fourth filter element 308, the fifth filter element 310, and the sixth filter element 312. A fourth level 356 includes the seventh filter element 314 and the eighth filter element 316. A fifth level 358 includes the ninth filter element 318 and the tenth filter element 320.

For the filter bank 300, five levels are used and a semi-log filter bank is created. The filter bank 300 produces finer resolution at low frequencies useful for speech analysis with 11 bands with variable bandwidth and a sampling rate (Fs)=4 kHz (maximum) to Fs=0.5 kHz (minimum).

It will be understood that signals enter each of the filter elements and as shown in FIG. 6, the signal is broken into bands having particular bandwidths. For example, a signal with bandwidth 0-8 kHz enters first filter element 302, where it is split into two signals: one with a bandwidth of 0-4 kHz and the other with a bandwidth of 4-8 kHz. The signal of bandwidth 4-8 kHz is then sent to the second filter element 304, where the signal is split into a signal of bandwidth 6-8 kHz and another signal with 4-6 kHz bandwidth. This type of bandwidth splitting occurs among the filter elements.

The signals then reach the energy estimation block 330. At the energy estimation block 330, the estimated energy for each band is obtained. This may be obtained, for example, by methods similar to those illustrated previously, such as:

E_est(k,n)=(1−time_avg)×E_est(k,n-1)+time_avg×abs(x(k,n))

Where x(k,n) is the signal output for the frequency band k for the time sample n, time_avg is the averaging time for the energy estimator defined by the equation and E_est(k,n) is the estimated energy, The estimated energy is read at fixed intervals. In certain aspects, the fixed time intervals could be 5 ms, 8 ms, 10 ms or another suitable interval.

In another aspect, the energy may be estimated by an accumulate and dump method at the fixed interval rate, as shown by

E_est(k,n)=E_est(k,n)+abs(x(k,n))

The energy estimate is reset at the end of the fixed interval after being read. Here n corresponds only to the set of samples corresponding to a pre-defined fixed interval.

After being processed by the front end filter bank, the energy estimates may be sent to the back end where a comparison is made of the estimates to predetermined patterns where each pattern represents a different phone. A predetermined set of criteria may be used to determine if a match is determined. When a match is determined, an indication of the match and an indication of the phone detected may be sent, for example, to an external processing device.

It will be appreciated that a single integrated circuit may include multiple filter elements and then configured according to one of the configurations of FIG. 2 or FIG. 3. That is, the integrated circuit may include all ten filter elements and multiplexers (or switches) are programmed to configure the chip as either the circuit of FIG. 2 or the circuit of FIG. 3. The multiplexers are not shown in these drawings for purposes of simplicity. The multiplexers (or switches) may be programmed from a command (or other control signal) originating from a processing device that is external to the microphone. The implementations of these filters could consist of one or multiple calculating blocks with the memory required to support the required number of filters. The number of the calculating blocks may be optimized for an area against parallel implementation trade-offs to meet different requirements.

It will also be appreciated that configurations other than that shown in FIG. 2 or FIG. 3 are possible with a different configuration of filter elements. The description above does not limit the possible number of configurations that may be used. The configurations possible are limited only by the multiplexers and memory designed into a particular hardware implementation.

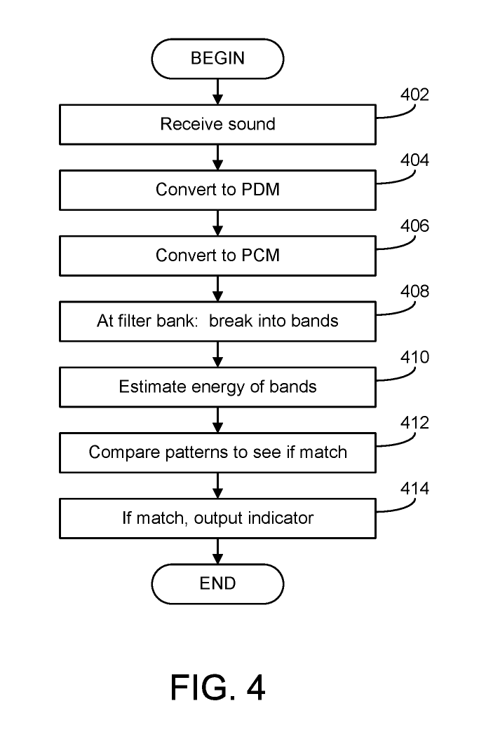

Referring now to FIG. 4, one example of the operation of a microphone system is described. At step 402, sound is received at a transducer (e.g., a MEMS transducer) and converted into an analog electrical signal.

At step 404, the analog electrical signal is converted from analog format to PDM format. At step 406, the PDM signal is converted from PDM format to PCM format. The PCM signal is received at the processing engine and more specifically at the front end filter bank of the processing engine.

At step 408 and at the filter bank, at individual times, the signal is broken into bands as shown in FIG. 6. Referring now to FIG. 6, at one filter element an incoming signal 601 is broken into a first band 602 of first frequencies and a second band 604 of second frequencies. As will be appreciated and in this example, this action divides down by two the number of samples across the 10 ms time period by selecting alternating samples during the filtering process for the upper and lower frequency filter-bank output. This is known as decimation by a factor of two.

At step 410 and at the energy estimator, the estimated energy for each band is obtained. For example, the estimated energy is obtained for the 6-8 kHz bandwidth, the 5-6 kHz bandwidth, and the 4-5 kHz bandwidth, and so forth. It will be appreciated that some or all of the bandwidths may overlap.

At step 412 and at the back end, the estimated energy is compared to the expected energy for a given phoneme and a determination is made if the phone or phoneme utterance is detected. Particular value ranges in particular bands indicate a particular phone has been detected. The front end and/or the back end may be programmed to suit the needs of a general population so the phone detection is tailored to a particular language and grammar model characteristic of the population, e.g., U.S. English as compared to British English. Alternatively, the front end and/or the back end may be programmed to suit the needs of a particular user, so that phone detection is tailored to the voice characteristics of a particular user.

At step 414, when a particular phone has been detected, an indication may be sent to an external processing device. The external processing device may take further actions once it has received the indication that a phone has been detected.

It will be appreciated that the filter bank is programmed and this can be accomplished during operation after manufacturing and on-the-fly. Multiplexers connect the various elements together and these are programmed by an external processing device using a command or command signal.

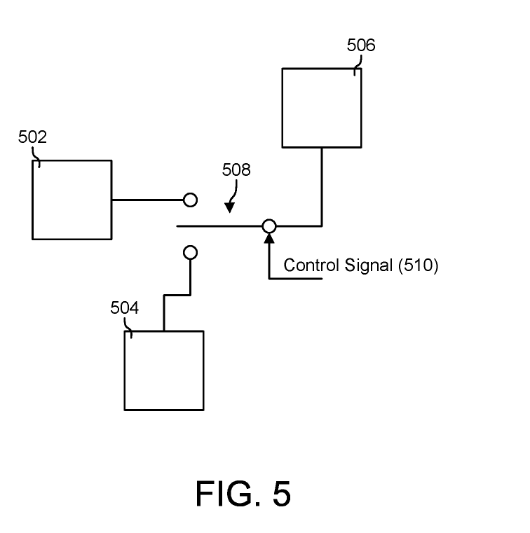

Referring now to FIG. 5, one example of configuring elements in a programmed or configurable front end of a specialized phone selecting VAD processing engine is described. For example, the circuit of FIG. 5 may represent apportion of the filter banks shown in FIG. 2 and FIG. 3. A first filter element 502, a second filter element 504, and a third filter element 506 are shown. The function of the filter elements 502, 504, and 506 may be the same or similar to the filter elements in FIG. 2 and FIG. 3. A multiplexer 508 (or some type of switching element) selectively couples the filter elements 502, 504, and 506. The switching position obtained by the multiplexer 508 is controlled by a control signal 510. The control signal 510 is created from instructions or parameters received from a source external to the microphone (e.g., an external processing device).

In one programming, the first filter element 502 is coupled to the third filter element 506. In another programming, second filter element 504 is coupled to the third filter element 506. It will be appreciated that the filter banks can have a multitude of multiplexers that couple various filter elements in a variety of different combinations depending upon how the filter bank is to be programmed. The example of FIG. 5 illustrates one portion of a filter bank (e.g., the filter banks shown in FIG. 2 and FIG. 3) and can be applied to other portions in a variety of different ways.

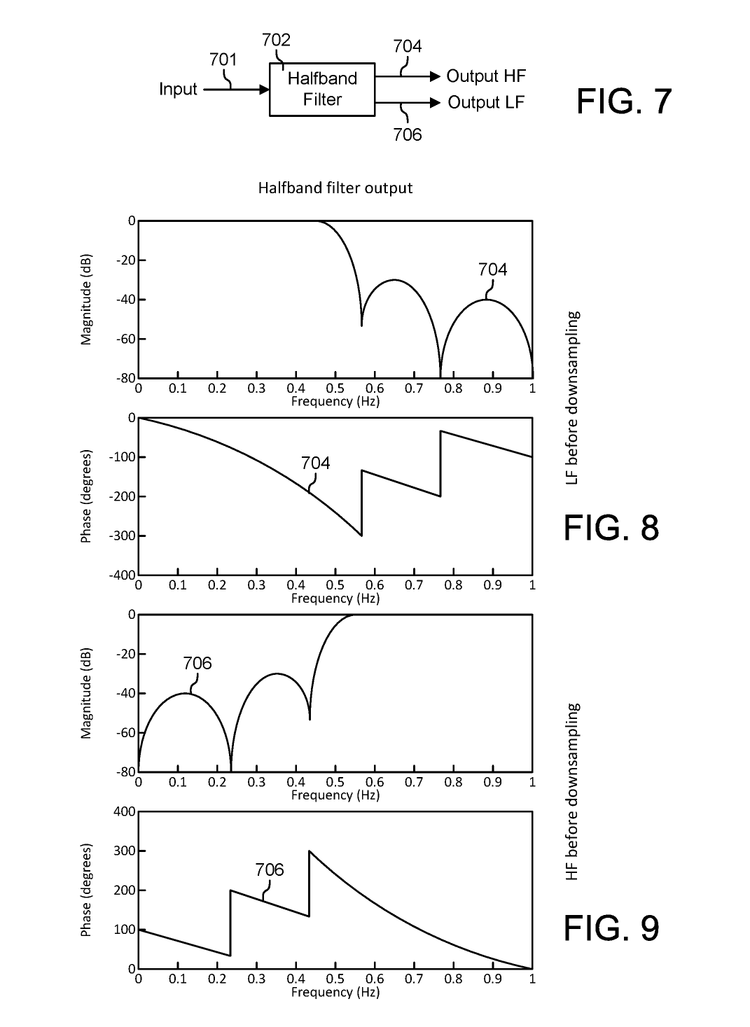

In some aspects, a half-band filter is used in a configuration which within limits can change the filter bank structure and still be low power. These filters may be used as the filter elements described above. As shown in FIG. 7, a half band filter 702 separates the input signals 701 into a low pass filter output 704 with half of the band width. At the same time it can output a high pass path output 706 of the signal with only one extra addition. The output 706 can be down-sampled by not storing the output 706 for each second sample. Down-sampling the high frequency (HF) output 706 will swap the frequency contents, which one needs to know for the later stages. FIG. 8 shows low frequency (LF) output 704 before down-sampling. FIG. 9 shows HF output 706 before down-sampling.

Half band filters provide low pass and high pass filtered signals. After filtering the sample rate Fs is halved by dropping alternate samples. Decimating the LPF keeps the order of frequency contents. Thus F1 and F1_{D} map to 0 Hz and F2 and F2_{D} map to f_{HB}. Decimating the HPF will swap the frequency contents, which one needs to know for the later stages. Thus F2 maps to F2_{D} and F3 maps to F1_{D}. FIG. 6 shows this process.

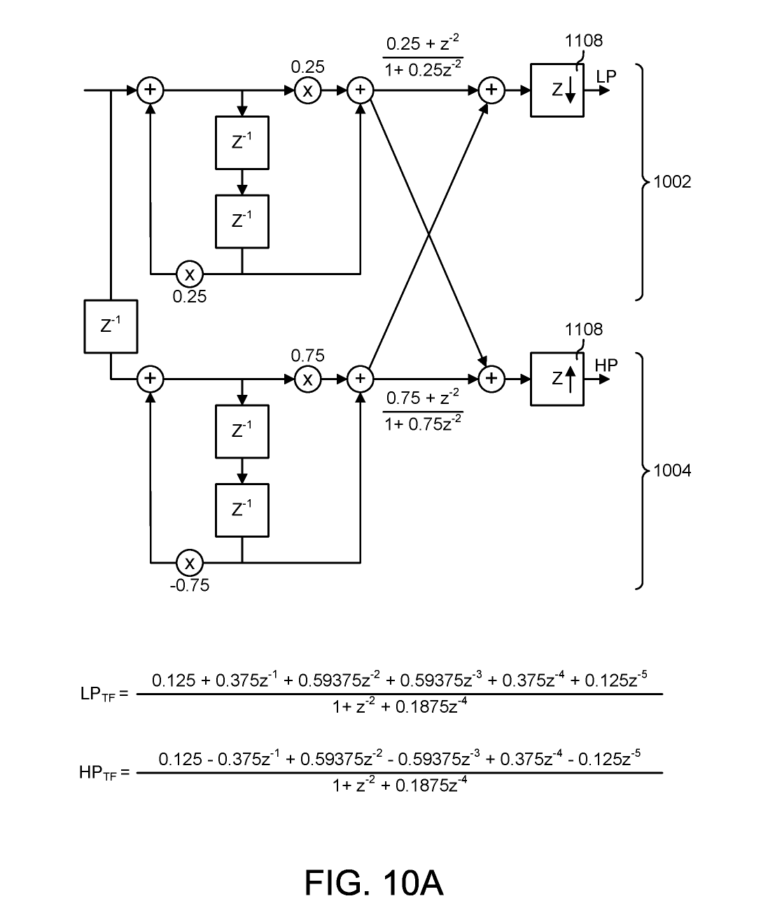

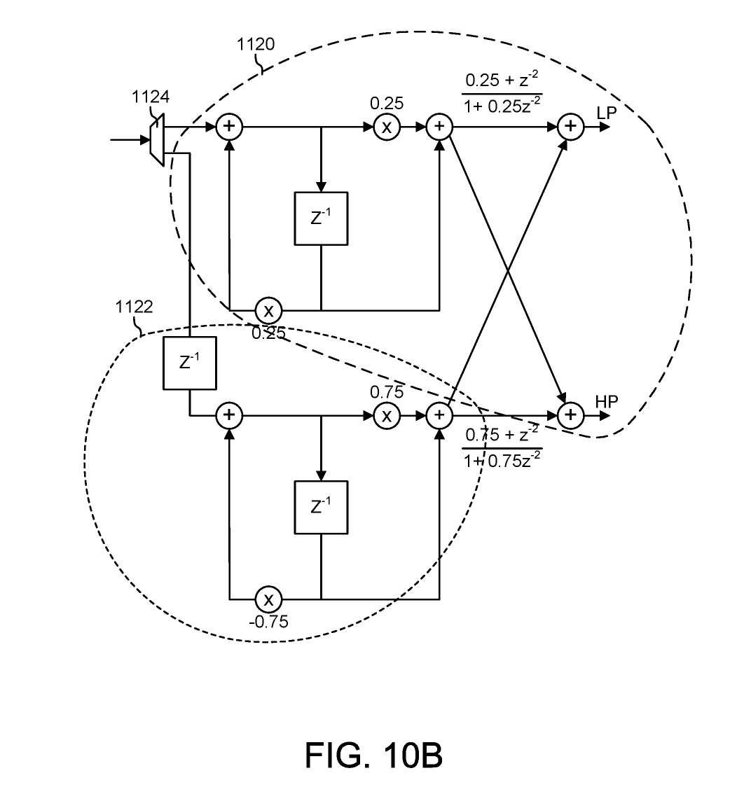

Referring now to FIG. 10A, a half band filter is implemented using 2 all pass filters 1002 and 1004 in parallel and may be also referred to as a wave filter. As shown, the sum or difference of those results in the low pass filter 1002 or high pass filters 1004. Each filter 1002 or 1004 includes various summing units and multipliers. The transfer function for each of the filters is shown below the drawings. Z⁻¹ represents a delay in the digital domain. Other examples are possible. Down converters 1108 are used to decimate the signal rate with a factor of 2 by removing every second sample between input to 1108 and the output of 1108. The result of the down conversion is shown in FIG. 6 and described elsewhere herein.

Referring now to FIG. 10B, one example of an implementation of the filter of FIG. 10A is described. A multiplexer 1124 is positioned at the input. When the first incoming sample arrives, the signal path 1120 is selected and this also updates the output. On the next incoming sample, the signal path 1122 is used. On the next sample, the signal path 1120 is used. In other words, toggling between the two signal paths occurs. In one aspect, the approach of FIG. 10B reduces the amount of power used by the filter by approximately a factor 2 (compared to approaches where no multiplexer is used, since only half of the gates are updated.

In another advantage, only half of the delay lines are used compared to when there is no multiplexer. This approach reduces the chip area need significantly.

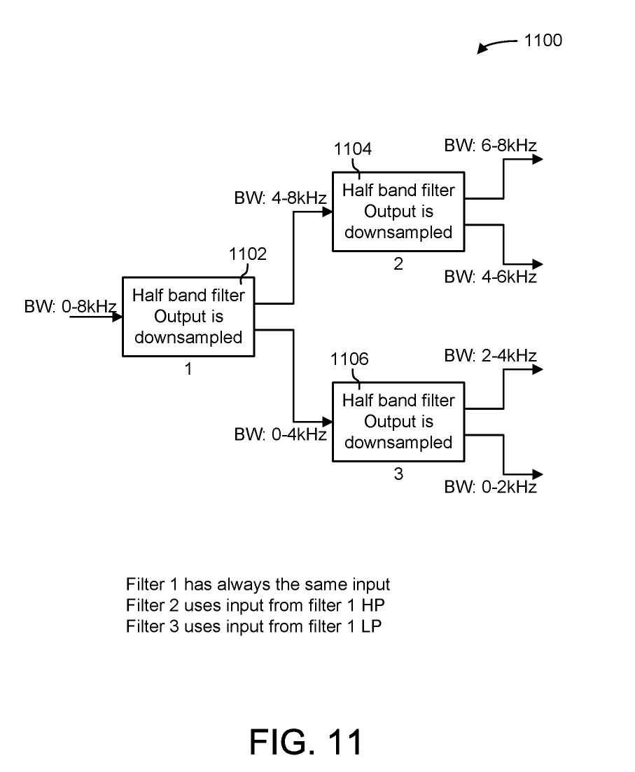

Referring now to FIG. 11, an example of a filter bank 1100 is described. In this example, the filter bank 1100 outputs 4 bands of equal bandwidth and uses 3 half band filters 1102, 1104, and 1106.

The first filter 1102 reads the input. The second filter 1104 is set to read the output from the HP output of the first filter 1102. The third filter 1106 is set to read the output from the LP output of the first filter 1102.

Instruction lines (for every input sample) are:

1. [1 2 0]

2. [1 3 0]

3. [0 0 0] repeat from 1 or just have a counter repeating the cycle.
0 means no operation

The instruction lines refer to FIG. 11. Filter 1102 runs at every sample where filter 1104 and 1106 runs every second sample since those are down samples with a factor 2.

The instruction lines should be read for every incoming sample. When the first incoming sample arrives, the first filter 1 and secondly filter 2 are run as described in the first instruction line (equals filter 1102 and 1104). When the second incoming sample arrives, the first filter 1 and secondly filter 3 are run as described in the second instruction line (equals filter 1102 and 1104). The third sample repeats the process by looking at instruction line 1 again and so forth.

Using this small instruction, programming of when the filters should run and how often they run is performed. In one aspect, the system also use a small table showing where each filter should read its input from.

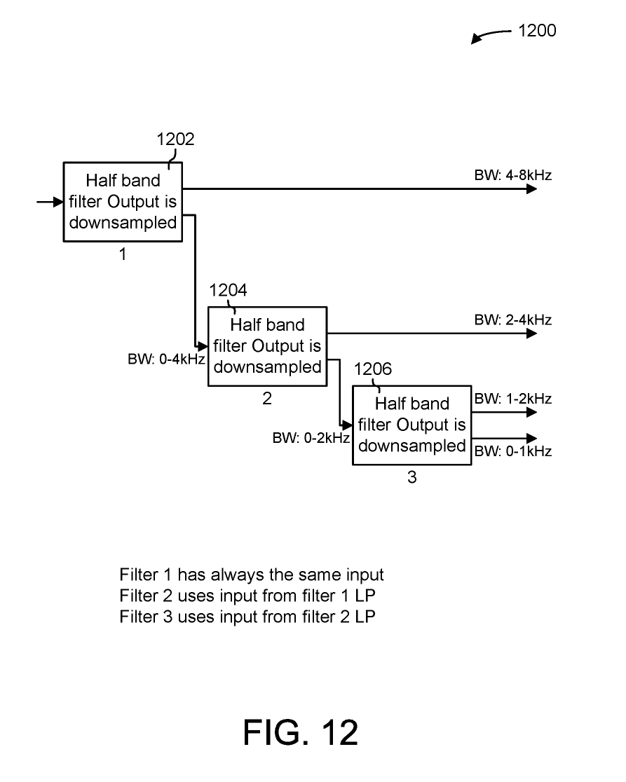

Referring now to FIG. 12, another example of a filter bank 1200 is described. The filter bank 1200 outputs 4 bands of log2 spaced bandwidth and uses 3 half band filters 1202, 1204, and 1206.

The first filter 1202 reads the input. The second filter 1204 is set to read the LF output of the first filter 1204. The third filter 1206 is set to read the LF output from the second filter 1204.

In this example, the instruction lines (for every input sample) are:

1. [1 2 3]

2. [1 0 0]

3. [1 2 0]

4. [1 0 0]

5. [0 0 0] repeat from 1 or just have a counter repeating the cycle.
0 means no operation.

The instruction lines refer to FIG. 12. Filter 1202 runs at every sample where filter 1204 runs every second sample. Filter 1206 runs at every forth sample. Each stage down samples with a factor 2.

The instruction lines should be read for every incoming sample. When the first incoming sample arrives, first filter 1 and secondly filter 2 and thirdly filter 3 are run as described in the first instruction line (equals filter 1202, 1204 and 1206).

When the second incoming sample arrives, only filter 1 is run as described in the second instruction line (equals filter 1202).

When the third sample arrives, the system runs first filter 1 and secondary filter 2 (equals filter 1202 and 1204).

When the forth incoming sample arrives, only filter 1 is run as described in the second instruction line (equals filter 1202). The instruction lines then repeat itself

It will be appreciated that the example filters and filters banks provided herein and their implementations are examples only, and other examples are possible.

Referring now to FIG. 13, one example of an approach for partial phrase detection is described. For illustrative purposes, this example assumes that the partial phrase “OK” is to be detected. Frames are received as are energy estimates from the front end. The approach uses different frequency bands or “bins” that are identified for each frame of data that is received. In one example, 8 bands may be used. In another example, 11 bands may be used. Other examples of different number of bands or bins are possible.

At step 1302, peak picking occurs. This step takes the energy estimates received from the front end and picks the local peak energy points within these energy estimates within a given time frame.

More specifically and in one aspect, for each frame a determination is made as to the peaks of sub-band energy envelope using differences based on proximity of the frequency bands. If BP[k,n]>BP[k−1,n] and BP[k,n]>BP[k+1,n] then mark BP[k,n] as a peak where BP[k,n] is the energy from the band pass filter k at time frame n.

At step 1304, valleys are determined between the peaks for a frame. In one aspect and between two successive local peaks a valley is determined by picking the minimum of the band energy values between those two local peaks. In one example, a peak is marked as “strong” if its magnitude is greater than the magnitude of valley on either side by a fixed threshold such as 10 dB. Other examples are possible.

At step 1306, phoneme counters are selectively adjusted. In this example, an “O” counter and a “K” counter are maintained.

The “O” counter is incremented if within a frame or a sequential set of frames there are strong peaks found in bin 2 and 6, or bin 3 and 6, or bin 4 and 6, otherwise counter is decremented. In one aspect, the “O” counter is capped between upper and lower bounds, typically 0 to 20 for time intervals between 10 ms and 30 ms corresponding to one or a plurality of sequential frames. Other combinations of counts and frame sizes are possible,

The “K” counter is incremented if in a frame there are strong peaks found in bin 2 and 7, or bin 3 and 7, or bin 2 and 8, or bin 3 and 8, otherwise counter is decremented. Counter is capped between upper and lower bounds, typically 0 to 20 for 25 ms frame size.

At step 1308, phoneme flags are selectively set. In these regards and if at any time “O” counter goes above a threshold, for example, 4 then “O” flag is set, otherwise unset. If at any time “K” counter goes above a threshold, for example, 4 then “K” flag is set, otherwise unset.

At step 1310, a state machine is utilized to determine whether a partial phrase has been determined. To take one example of the operation of the state machine, if a state transition has occurred from “O” flag and “K” flag as zero to a state where “O” flag is set to 1 followed by another state transition to where “K” flag is set to 1 then “OK” has been detected.

To take another example using the phrase “Hi,” if a state transition has occurred from “H” flag and “I” flag as zero to a state where “H” flag is set to 1 followed by another state transition to where “I” flag is set to 1 then “Hi” has been detected.

Referring now to FIG. 14, one example of spectrograph displays 1402 and 1404 are shown. The display 1402 is divided into 8 bands 1420, 1422, 1424, 1426, 1428, 1430, 1432, 1434, and 1436 as shown (e.g., band 1420 is for the 0 to 8 kHz full band signal, while band 1 is for 0-1 kHz bin). It can be seen that for a certain frame number (identified on the x-axis) peaks 1436 occurs in bin 1, peak 1438 occurs in bin 4, and peak 1440 occurs in bin 6. If “O” matches this pattern (peaks occurring in bins 1, 4, and 6), then an “O” is determined to be detected. As shown in FIG. 14, Band0 energy levels provide the overall energy of the signal and may be used to threshold signals which have very low power and thus not considered relevant. The threshold value may be programmed during the manufacturing process or on the fly.

The display 1404 is divided into 11 bands 1450, 1452, 1454, 1456, 1458, 1460, 1462, 1464, 1466, 1468, 1470, and 1472 as shown (e.g., band 1450 is for the 0 to 8 kHz full band signal while band 1 is for 0 to 0.25 kHz bin). It can be seen that for a certain frame number (identified on the x-axis) peaks 1476 occurs in bin 6, peak 1478 occurs in bin 8, and peak 1480 occurs in bin 11. If “O” matches this pattern (peaks occurring in bins 6, 8, and 11), then an “O” is determined to be detected. As mentioned and as shown in FIG. 14, Band0 energy levels provide the overall energy of the signal and may be used to threshold signals which have very low power and thus not considered relevant. The threshold value may be programmed during the manufacturing process or on the fly.

Preferred embodiments of this invention are described herein, including the best mode known to the inventors for carrying out the invention. It should be understood that the illustrated embodiments are exemplary only, and should not be taken as limiting the scope of the invention.

1.-25. (canceled)

26. A assembly method of detecting a particular phoneme sound, the method comprising:
converting an acoustic signal sensed by a transducer of a microphone assembly to an electrical signal representative of the acoustic signal;
a separating the electrical signal into a plurality of frequency bands by a configurable filter bank, said configurable filter bank comprising a plurality of filter elements and switches configurable to selectively interconnect selective ones of the filter elements based a control signal from a control interface;
determining energy estimates for the plurality of frequency bands;
comparing the plurality of energy estimates with expected energies of the plurality of frequency bands for the particular phoneme sound; and
indicating occurrence of the particular phoneme sound in response to determining there is a match between the plurality of energy estimates and the expected energies of the plurality of frequency bands for the particular phoneme sound.

27. The method of detecting a phoneme sound according to claim 26, further comprising:
configuring the filter bank to accommodate different characteristics of the acoustic signal, wherein the different characteristics of the acoustic signal include at least one of regional speech dialects or voice characteristics of a particular user.

28. The method of detecting a phoneme sound according to claim 26, wherein determining the energy estimates of the plurality of frequency bands further comprises:
determining, within a predetermined time frame, n, one or more peak energy bands of the plurality of frequency bands.

29. The method of detecting a phoneme sound according to claim 28, wherein determining energy estimates of the plurality of frequency bands further comprises:
determining, within the predetermined time frame, n, one or more energy valley bands of the plurality of frequency bands, wherein said one or more energy valley bands are selected as one or more bands with a minimum energy between two peak energy bands.

30. The method of detecting a phoneme sound according to claim 29, wherein determining the energy estimates of the plurality of frequency bands further comprises:
marking one of the one or more peak energy bands as a strong energy peak band if its magnitude exceeds a magnitude of adjacent energy valley bands by at least 10 dB.

31. The method of detecting a phoneme sound according to claim 30, further comprising:
incrementing a phoneme counter in response to detecting, within a time frame or a sequential set of time frames, strong peak energy bands in a predetermined subset of the plurality of frequency bands; and
decrementing the phoneme counter in response to not detecting, within the time frame or the sequential set of time frames, the strong peak energy bands in the predetermined subset of frequency bands.

32. The method of detecting a phoneme sound according to claim 31, further comprising:
comparing the phoneme counter with a count threshold; and
raising a phoneme flag in response to the phoneme counter exceeding the count threshold to indicate the presence of the particular phoneme sound.

33. The method of detecting a phoneme sound according to claim 28, further comprising:
determining whether the energy estimates of the plurality of frequency bands is above or below a pre-programmed threshold to determine whether a full band signal constitutes sufficient energy to be considered relevant to the phoneme sound detection or is to be ignored.

34. The method of detecting a phoneme sound according to claim 26, wherein the configurable filter bank comprises a plurality of half-band filters, each half-band filter providing a lowpass filtered signal and a highpass filtered signal.

35. The method of detecting a phoneme sound according to claim 34, each of half-band filters comprises two allpass filters connected in parallel.

36. The method of detecting a phoneme sound according to claim 34, wherein the plurality of half-band filters comprises:
a first half-band filter configured to split the electrical signal into a first lowpass filtered signal and a first highpass filtered signal;
a second half-band filter configured to split the first lowpass filtered signal into a second lowpass filtered signal and a second highpass filtered signal; and
a third half-band filter configured to split the first highpass filtered signal into a third lowpass filtered signal and a third highpass filtered signal.

37. The method of detecting a phoneme sound according to claim 34, wherein the lowpass filtered signal is decimated by a factor of two and the highpass filtered signal is decimated by a factor of two.

38. A microphone assembly comprising:
a microelectromechanical systems (MEMS) transducer configured to convert an acoustic signal to an electrical signal representative of the acoustical signal;
a configurable filter bank having an input coupled to an output of the transducer, the filter bank configured separate the electrical signal into a plurality of frequency bands, said configurable filter bank comprising a plurality of filter elements and switches configurable to selectively interconnect selective ones of the filter elements based a control signal from a control interface,
an energy estimator circuit configured to determining energy estimates for each of the plurality of frequency bands;
a phoneme sound detector configured to compare the plurality of energy estimates with expected energies of the plurality of frequency bands for a particular phoneme sound; and
indicating occurrence of the particular phoneme sound if there is a match between the plurality of energy estimates and the expected energies of the plurality of frequency bands of the particular phoneme sound.

39. The microphone assembly according to claim 38, wherein the energy estimator circuit is configured to determine, within a predetermined time frame, n, one or more peak energy bands of the plurality of frequency bands.

40. The microphone assembly according to claim 39, wherein the energy estimator circuit is configured to determine, within the predetermined time frame, n, one or more energy valley bands of the plurality of frequency bands, wherein said one or more energy valley bands are selected as one or more bands with a minimum energy between two peak energy bands.

41. The microphone assembly according to claim 40, wherein the energy estimator circuit is configured to mark one of the one or more peak energy bands as a strong energy peak band in response to determining its magnitude exceeds a magnitude of adjacent energy valley bands by a fixed threshold such as by 10 dB.

42. The microphone assembly according to claim 41, wherein the energy estimator circuit is configured to increment a phoneme counter in response to detecting, within a time frame or a sequential set of time frames, strong peak energy bands in a predetermined subset of the plurality of frequency bands, and wherein the energy estimator circuit is configured to decrement the phoneme counter in response to not detecting, within the time frame or the sequential set of time frames, the strong peak energy bands in the predetermined subset of frequency bands.

43. The microphone assembly according to claim 41, wherein the energy estimator circuit is configured to compare the phoneme counter with a count threshold and raise a phoneme flag if the phoneme counter exceeds the count threshold to indicate the presence of the particular phoneme sound.

44. The microphone assembly according to claim 38, wherein the control interface is coupled to the configurable filter bank for receipt of commands from an external processing device, said commands being effective to configure and connect selective ones of the plurality of filter elements in the configurable filter bank.

45. The microphone assembly according to claim 38, wherein the configurable filter bank comprises a plurality of half-band filters, each half-band filter configured to generate a lowpass filtered signal and a highpass filtered signal.
